(19) United States
(12) Patent Application Publication
(10) Pub. No.: US 2017/0318368 A1
(43) Pub. Date: Nov. 2, 2017

(54) AmpLegs Tilt-Back System for Musical Instrument Amplifiers and Speaker Cabinets

(71) Applicant: Michael Peter Sucato, Boulder, CO (US)

(72) Inventor: Michael Peter Sucato, Boulder, CO (US)

(21) Appl. No.: 15/585,155

(22) Filed: May 2, 2017

Related U.S. Application Data
(60) Provisional application No. 62/330,251, filed on May 2, 2016.

(51) Int. Cl. H04R 1/02; F16M 13/00

(52) U.S. Cl. CPC H04R 1/026; F16M 13/005; H04R 2201/025

(57) ABSTRACT

The kit form of subject invention consists of 2 retractable spring actuated steel legs that come in various sizes and two heavy duty fasteners that adhere to rear of musical instrument amplifiers, speaker cabinet or other device. The legs, referred to as AmpLegs, require no drilling or screws for installation on most amps or cabinets, while others require the AmpLegs Mounting Blocks accessory. AmpLegs attach to rear of cabinet via dual lock fasteners to provide support while cabinet is tilted back. Tilt angle is adjusted by detaching the AmpLegs from the dual lock fasteners and then attaching them back to the fasteners at a slightly higher or lower point on the fasteners, effectively increasing or decreasing tilt angle.

### FIELD OF INVENTION

This invention relates to musical instrument amplifier and speaker modifications and accessories.

### PROBLEM BACKGROUND OF THE INVENTION

Current integrated amplifier tilt-back systems require invasive installation methods, such as drilling holes and using screws to attach legs or other device to facilitate desired tilt angle of amplifier cabinet. Other solutions require you to haul a detached separate stand to achieve the same goal, but fall short as tone is diminished when amplifier is lifted off the ground (see Bass Coupling Effect).

### SOLUTION

This invention (AmpLegs—Advanced Tilt-Back System for Musical Instrument Amplifiers and Speaker Cabinets) solves both of these problems by using high strength fasteners that provide a stable effective connection between amplifier cabinet and tilt-back legs without having to drill holes and apply screws. Ease of installation is dramatically increased while installation time is dramatically decreased. Also, the AmpLegs system is fully integrated once attached, so no need for a separate stand that effectively depletes ambient tone as amplifier is lifted from ground. AmpLegs tilt-back legs come in 5 sizes: XS(extra small); S(small); M(medium); L(large); XL(extra large) and will fit virtually any combo amplifier or speaker cabinet up to 90 lbs or 30″ in height.

### DESCRIPTION

The AmpLegs system was designed to allow stable integrated tilt-back support at various angles for musical instrument amplifiers and speaker cabinets. The AmpLegs system consists of 2 spring actuated legs and two heavy duty fasteners. Both legs are designed to be attached to rear of amplifier or speaker cabinet via heavy duty fasteners. The AmpLegs employ a spring tension actuator tab that when depressed, extend the leg for tilt support and when pulled to up position, allow leg to retract back into a flush locked position for transport.

One of the unique features of the AmpLegs tilt-back system is the easy installation method itself, which does not require screws or drilled holes to attach the legs. This dramatically increases ease of installation while decreasing time to install. The AmpLegs system typically installs in less then 5 minutes compared to install times of other integrated tilt-back systems which typically exceed 2 hours and involve invasive drilling.

AmpLegs tilt-back legs come in 5 sizes: XS(extra small); S(small); M(medium); L(large); XL(extra large) and will fit virtually any combo amplifier or speaker cabinet up to 90 lbs or 30″ in height.

### UTILITY

From a utility perspective, tilting back amplifiers or speaker cabinets using AmpLegs provides important advantages to the user. First and foremost is the optimization of the speaker's projection path in reference to the player's ear. This allows the player to properly hear actual volume and tone from the amplifier and make educated adjustments essential in delivering live performances. Secondly, one can avoid “beaming” audience listeners who might be in proximity of the speaker's hot spot, essentially drowning out other audio sources.

The AmpLegs system is an integrated, spring loaded leg extension device that It is also the first and only integrated amplifier tilt system that doesn't require drilling or screws.

### SPECIFICATIONS

Height Between 3″ and 12″ depending on size of AmpLegs

Width Between 0.5″ and 0.75″ depending on size of AmpLegs

Depth Extended Between 3″ and 6″

Depth Depressed Between 1″ and 2″

Weight Between 6 oz. and 9 oz. depending on AmpLegs dimensions

Materials Stainless Steel and Rubberized Plastic

### BRIEF DESCRIPTION OF DRAWINGS

FIG. 1 is a cross section view of leg, including both extension leg section, mount section, anti-skid rubber foot and actuator lever.

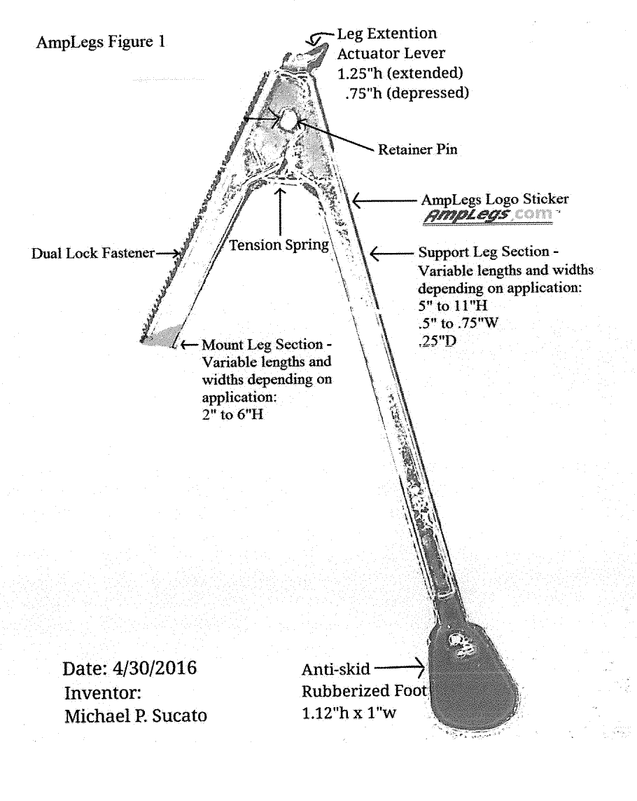

FIG. 2 is a view of extended leg

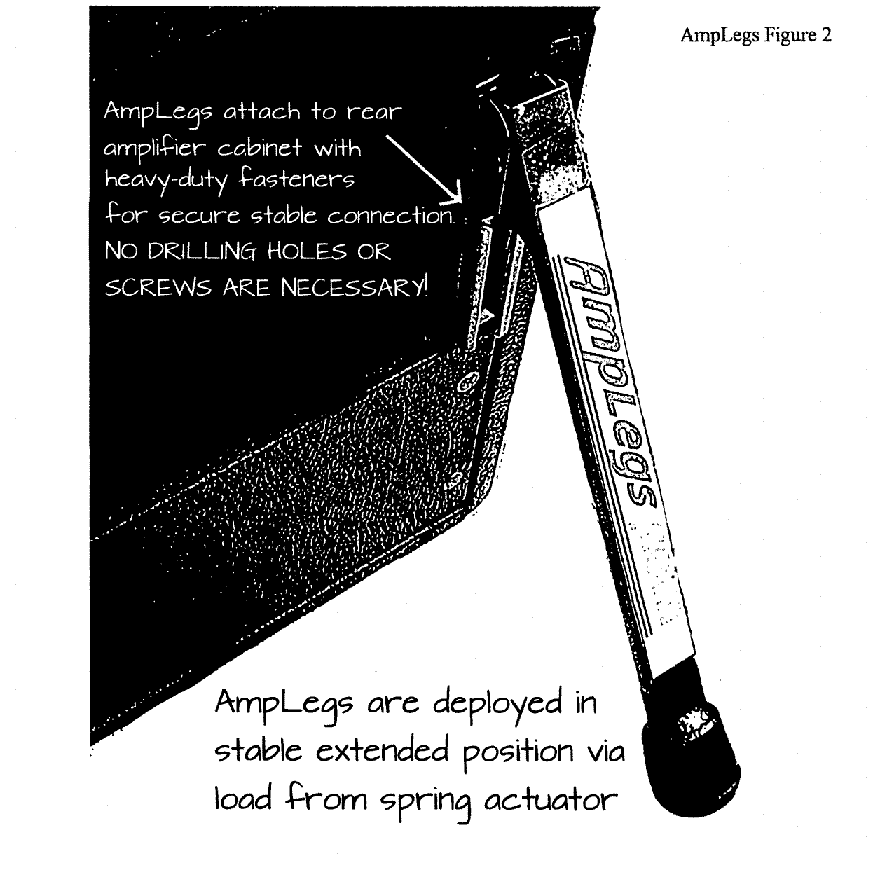

FIG. 3 is a view of leg in stowaway locked position

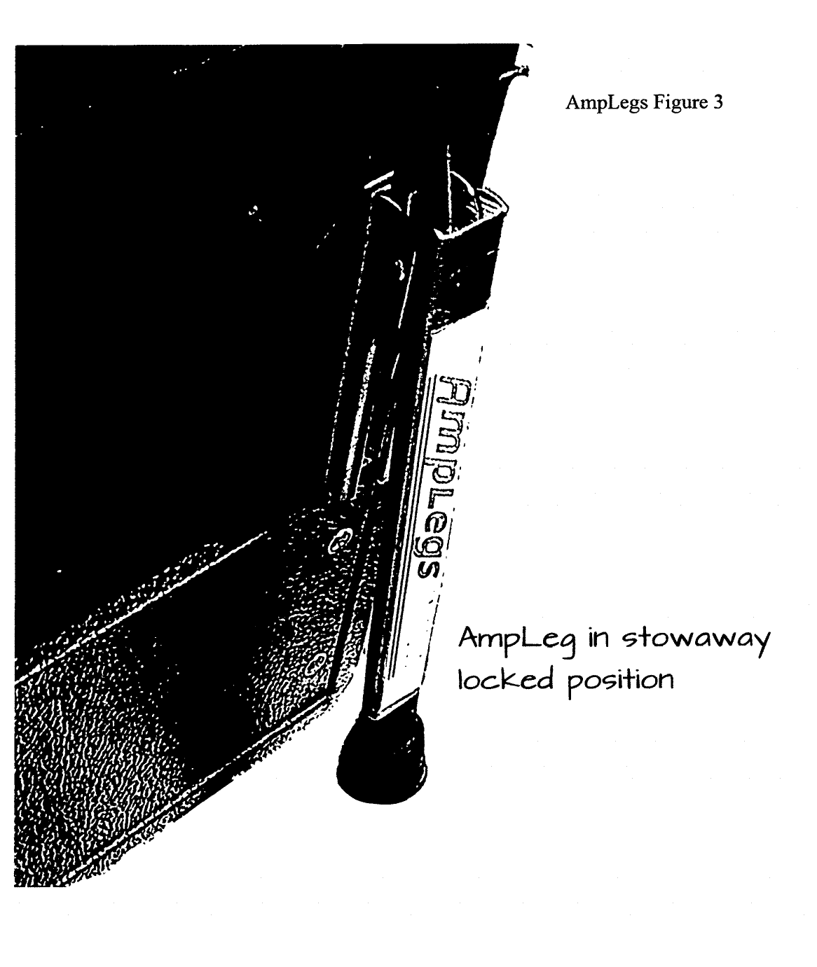

The invention claimed is:

1. Amplifier or speaker cabinet tilt back support apparatus comprising of the following:
Leg Assembly: Extension leg section and mounting leg section, wherein extension leg and mounting leg sections are joined together by metal retainer pin, spring and actuator tab. Leg section has rubberized anti-slip foot and AmpLegs logo sticker label. Mounting Leg section has fastener strip adhered. A small metal cam lever exists between both extension leg and mounting leg sections, which allows for leg extension and retraction movements.
Separate Fastener strip that is 0.5″ longer than leg mount section is used as an anchor point for leg assembly and adheres to rear of amplifier cabinet.
Note: In the AmpLegs Kit form, there are 2× leg assemblies and 2× fastener strips

2. The apparatus of claim 1, wherein installation to amplifier cabinet can occur without drilling holes and using screws or bolts.

3. The apparatus of claim 1, wherein leg mount section “snaps” into the fastener strip previously adhered to rear of amplifier cabinet.

4. The apparatus of claim 1, wherein tilt back angle adjustment is done by detaching an attaching leg mount section at a slightly higher or lower point on the fasteners, effectively increasing or decreasing tilt angle.
